(19) United States
(12) Patent Application Publication
(10) Pub. No.: US 2013/0002228 A1
(43) Pub. Date: Jan. 3, 2013

(54) CURRENT SOURCE WITH LOW POWER CONSUMPTION AND REDUCED ON-CHIP AREA OCCUPANCY

(75) Inventors: Yanyi L. WONG, Bellevue, WA (US); Agustinus Sutandi, Issaquah, WA (US)

(73) Assignee: SYNOPSYS INC., Mountain View, CA (US)

(21) Appl. No.: 13/171,491

(22) Filed: Jun. 29, 2011

(51) Int. Cl. G05F 3/16

(52) U.S. Cl. 323/317; 323/312

(57) ABSTRACT

A current source with low power consumption and reduced on-chip area occupancy. The current source for providing a constant current to a load includes a first circuit that generates a reference current. The first circuit includes a first plurality of interconnected transistors. The current source also includes a characteristic resistor, coupled to the first circuit, that determines value of the reference current. The current source further includes a second circuit and a third circuit. The second circuit, coupled to the first circuit and to the load, generates an output current that is identical to the reference current. The second circuit includes a second plurality of interconnected transistors. The third circuit, coupled to the first circuit, drives a multiple of the reference current into the characteristic resistor. The third circuit includes a third plurality of interconnected transistors.

### TECHNICAL FIELD

Embodiments of the disclosure relate to a current source that provides a constant current to a load.

### BACKGROUND

In an electronic system, there is often a need to provide a flow of current into a load such that the current is constant almost regardless of an impedance of the load. For example, to set an amplifier at a particular operating point, a bias current can be applied. The bias current has to be maintained at a constant level. In one example, a constant bias current is needed for the control of oscillators and timing signals. In another example, a constant bias current is needed is for generation of high-voltage control signals used in a non-volatile memory, for example a flash memory.

A current source that can provide a constant current typically includes transistors that provide a current gain. Usually, the current gain varies substantially across instances of transistors. Therefore the current source needs to be designed such that an output current of the current source is independent of the current gain of the transistors. A current mirror is used to produce the constant current of the desired level.

Currently, electronics need to consume less current so as to maximize battery life. Hence, current sources need to supply reliable and low levels of the current. By Ohm's law, a low current can be produced by the current source by increasing a size of a resistor that determines a level of current. However, increasing the size of the resistor consumes more area on an integrated circuit. Also, a certain type of resistor is more likely to be subject to variation of resistance with temperature, thereby compromising a constancy of the current that is provided by the current source.

Hence, there is a need for a current source that consumes less power, occupies less area in an integrated circuit, and is stable against temperature fluctuations and other environmental factors, for example power supply voltage fluctuations and manufacturing variations.

### SUMMARY

An example of a current source for providing a constant current to a load includes a first circuit that generates a reference current. The first circuit includes a first plurality of interconnected transistors. The current source also includes a characteristic resistor coupled to the first circuit. The characteristic resistor determines value of the reference current. The current source further includes a second circuit coupled to the first circuit and to the load. The second circuit generates an output current that is identical to the reference current. The second circuit includes a second plurality of interconnected transistors. Further, the current source includes a third circuit coupled to the first circuit. The third circuit drives a multiple of the reference current into the characteristic resistor. The third circuit includes a third plurality of interconnected transistors.

Another example of a current source for providing a constant current to a load includes a first circuit that generates a reference current. The current source also includes a second circuit coupled to the first circuit and to the load. The second circuit generates an output current that is identical to the reference current. The current source further includes a characteristic resistor coupled to the second circuit. The characteristic resistor determines value of the reference current. Further, the current source includes a third circuit coupled between the first circuit and the second circuit. The third circuit drives a multiple of the output current into the characteristic resistor. Moreover, the current source includes a resistor coupled to the first circuit.

An example of a method of providing a constant current to a load includes generating a reference current. The method also includes driving a multiple of the reference current into a characteristic resistor. The method further includes determining a value of the reference current by the characteristic resistor based on the reference current and the multiple of the reference current. Further, the method includes generating an output current that is identical to the reference current. Moreover, the method includes providing the output current to the load.

### BRIEF DESCRIPTION OF THE DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram illustrating a current source of Vittoz-style architecture, in accordance with one embodiment;

FIG. 2 is a schematic diagram of a current source of Vittoz-style architecture implemented in complementary metal oxide semiconductor (CMOS) technology, in accordance with one embodiment;

FIG. 3 is a schematic diagram of a current source of Vittoz-style architecture implemented in bipolar junction transistor (BJT) technology, in accordance with one embodiment;

FIG. 4 is a block diagram illustrating a current source of Widlar-style architecture, in accordance with one embodiment;

FIG. 5A is a schematic diagram of a current source of Widlar-style architecture implemented in complementary metal oxide semiconductor (CMOS) technology, in accordance with one embodiment;

FIG. 5B is a schematic diagram of a current source of Widlar-style architecture implemented in bipolar junction transistor (BJT) technology, in accordance with one embodiment; and

FIG. 6 is a flow diagram illustrating a method of providing a constant current to a load, in accordance with one embodiment.

### DETAILED DESCRIPTION OF THE EMBODIMENTS

In one embodiment, current source, as used in the disclosure, refers to a device that produces a constant and pre-determined level of current regardless of a load to which the device delivers the current. In one example, the current source includes two circuits; a first circuit producing a reference current, and a second circuit reproducing a multiple of level of the current in the first circuit, and delivering such current into the load. In one example, the multiple equals unity.

In one embodiment, current mirror, as used in the disclosure, refers to a circuit designed to copy a current through one active device by controlling the current in another active device of the circuit, keeping an output current constant. In one example, the second circuit is a current mirror to the first circuit, and generates the output current that is identical to the reference current in the first circuit.

In one embodiment, characteristic resistor, as used in the disclosure, refers to a resistor that is a component of the current mirror and that determines the level of the current generable by the current mirror.

In one embodiment, volt-equivalent of temperature (U_{T}), as used in the disclosure, is a voltage level associated with a temperature, and is defined to equal the temperature (T) in degrees Kelvin multiplied by the Boltzmann constant k (k=1.38×10⁻²³ in System International (SI) units) divided by the charge q of an electron (q=1.6×10⁻¹⁹ Coulombs). Thus volt-equivalent of room temperature, which is 300 degrees Kelvin, can be calculated as 26 millivolts.

The current generable by the current source is determined by the characteristic resistor. To generate low levels of current, Ohm's Law can be applied and size of the characteristic resistor can be increased. However, such an increase results in undesirable effects, for example increase in on-chip area. The present disclosure offers a solution to the problem of needing to use a large characteristic resistor by adding a circuit referred to herein as an auxiliary current mirror. The present disclosure is described in context of current mirrors that are of Vittoz-style architecture and current mirrors that are of Widlar-style architectures. It will apparent to one of ordinary skill in the art that system of using the auxiliary current mirror in order to reduce the size of the characteristic resistor applies to a current mirror of an architecture that uses the characteristic resistor. Similarly, the disclosure applies to multiple semiconductor technologies. The present disclosure is described exemplarily for complementary metal oxide semiconductor (CMOS) and bipolar junction transistor (BJT) technologies.

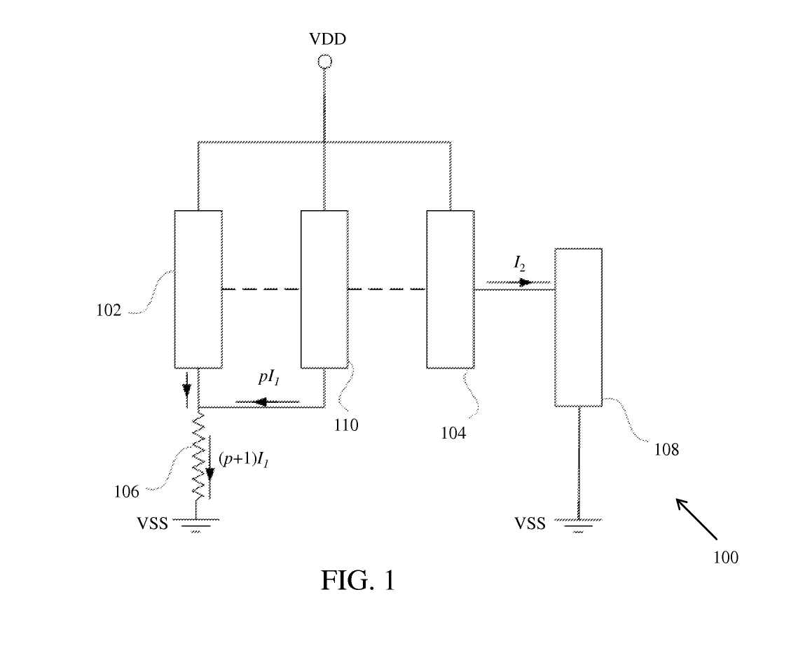

FIG. 1 is a block diagram illustrating a current source 100 of Vittoz-style architecture, in accordance with one embodiment.

The current source 100 achieves a desired value of output current without increasing size of a characteristic resistor R₀ 106. The current source 100 includes a first circuit 102, a second circuit 104, a characteristic resistor 106, a third circuit 110, and a load 108. The first circuit 102 is coupled between a power supply (VDD) and the characteristic resistor 106. The third circuit 110 is coupled to the power supply, and to the first circuit 102. The second circuit 104 is coupled to the power supply, and between the third circuit 110 and the load 108. The characteristic resistor 106 and the load 108 are further coupled to a ground supply (VSS). The first circuit 102 includes a first plurality of interconnected transistors, the second circuit 104 includes a second plurality of interconnected transistors, and the third circuit 110 includes a third plurality of interconnected transistors. The first circuit 102 generates a reference current I₁ that flows through the characteristic resistor 106. The second circuit 104 mirrors the first circuit 102. The third circuit 110 is an auxiliary current mirror that drives a current which equals a multiple p of the reference current I₁ into the characteristic resistor 106. The current flowing through the characteristic resistor 106 is then p+1 times the reference current I₁, which sustains voltage across the characteristic resistor 106 by using a value of resistance that is p+1 times lower. A current I₂ which is a pre-designed multiple of the reference current I₁, is generated by the second circuit 104. The current I₂ is further provided to the load 108.

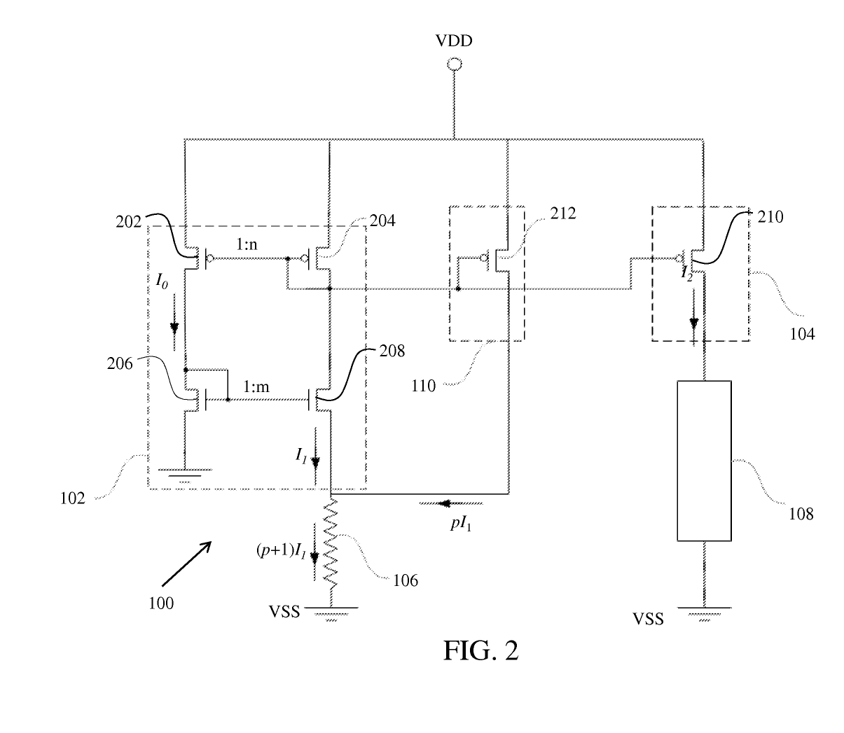

FIG. 2 is a schematic diagram of the current source 100 of Vittoz-style architecture implemented in complementary metal oxide semiconductor (CMOS) technology, in accordance with one embodiment.

The first plurality of interconnected transistors in the first circuit 102 includes a first p-type metal oxide semiconductor (PMOS) transistor 202, a second PMOS transistor 204, a first n-type metal oxide semiconductor (NMOS) transistor 206, a second NMOS transistor 208. The first PMOS transistor 202 has a source coupled to the power supply. The second PMOS transistor 204 has a gate coupled to a gate of the first PMOS transistor 202 and a source coupled to the power supply. The first NMOS transistor 206 has a drain coupled to a drain of the first PMOS transistor 202 and a source coupled to the ground supply. The second NMOS transistor 208 has a gate coupled to a gate of the first NMOS transistor 206, a drain coupled to a drain of the first PMOS transistor 202, and a source coupled to the characteristic resistor 106. The second plurality of interconnected transistors in the second circuit 104 includes a PMOS transistor 210. The PMOS transistor 210 has a gate coupled to the gate of the first PMOS transistor 202, a source coupled to the power supply, and a drain coupled to the load 108. The third plurality of interconnected transistors in the third circuit 110 includes a PMOS transistor 212. The PMOS transistor 212 has a gate coupled to the gate of the first PMOS transistor 202, a source coupled to the power supply, and a drain coupled between the source of the second NMOS transistor 208 and the characteristic resistor 106. In some embodiments, the first PMOS transistor 202, the second PMOS transistor 204, the first NMOS transistor 206, and the second NMOS transistor 208 can have identical characteristics irrespective of different sizes.

The first PMOS transistor 202, the second PMOS transistor 204, the first NMOS transistor 206, and the second NMOS transistor 208, in the first circuit 102, together generate the reference current I₁, value of which is determined by the characteristic resistor 106. The first PMOS transistor 202 and the second PMOS transistor 204 differ in sizes based on a ratio of 1:n, where n is a first integer value. Similarly, the first NMOS transistor 206 and the second NMOS transistor 208 differ in sizes based on a ratio of 1:m, where m is a second integer value. In the present disclosure, size of each transistor is defined as ratio of width of the transistor to length of the transistor. The PMOS transistor 210 generates the current I₂ which is an output current provided to the load 108. The PMOS transistor 212 further is the auxiliary current mirror that drives a current that equals p times the reference current I₁ into the characteristic resistor 106. The PMOS transistor 212 is p times larger than the second PMOS transistor 204, and has similar gate voltage and source voltage to the second PMOS transistor 204.

Gates of the first PMOS transistor 202 and the second PMOS transistor 204 are at a voltage lower than respective sources, hence biasing the first PMOS transistor 202 and the second PMOS transistor 204 to operate in a saturation mode. In the saturation mode, a current I₀ and the reference current I₁ that flow respectively through the first PMOS transistor 202 and the second PMOS transistor 204 are proportional to the sizes of respective transistors and otherwise depend only on gate-to-source voltages. As the gate-to-source voltages of the first PMOS transistor 202 and the second PMOS transistor 204 are identical, the current I₀ and the reference current I₁ are in the ratio of the sizes of the transistors, that is, I₀/I₁=1/n.

Gate-to-source voltages of the first NMOS transistor 206 and the second NMOS transistor 208 are lower than threshold voltage of the first NMOS transistor 206 and the second NMOS transistor 208, hence biasing the first NMOS transistor 206 and the second NMOS transistor 208 to operate in weak inversion mode. Typically, the current through a transistor in weak inversion mode is proportional to size of the transistor, to negative exponential of gate voltage of the transistor, and to the negative exponential of source voltage of the transistor divided by the volt-equivalent of temperature. Gate voltages of the first NMOS transistor 206 and the second NMOS transistor 208 are identical, whereas the source voltage of the first NMOS transistor 206 is zero volts and the source voltage of the second NMOS transistor 208 is, by Ohms law, R₀I₁.R₀ is value of the characteristic resistor 106. Therefore, the ratio of the current I₀ and the reference current I₁ through the first NMOS transistor 206 and the second NMOS transistor 208, which is I₀/I₁, and the ratio of the current I₀ and the reference current I₁ through the first PMOS transistor 202 and the second PMOS transistor 204, equals the ratio of the sizes of the first NMOS transistor 206 and the second NMOS transistor 208 multiplied by the negative exponential of R₀I₁/U_{T}. In mathematical terms, relationship between I₀/I₁ and the sizes of the first NMOS transistor 206 and the second NMOS transistor 208 can be given in equation 1 below:

$$\frac{{I}_{0}}{{I}_{1}} = \frac{1}{m} {e}^{{R}_{0} {I}_{1} / {U}_{T}} = \frac{1}{n} , \qquad ( 1 )$$

where m indicates the ratio of the size of the second NMOS transistor 208 to that of the first NMOS transistor 206.

The PMOS transistor 212 mirrors the second PMOS transistor 204. On rearrangement of equation 1, the characteristic resistor 106, of value R₀, is given as

$${R}_{0} = \frac{{U}_{T}}{( p + 1 ) {I}_{1}} ln \frac{m}{n} , \qquad ( 2 )$$

R₀, for the level of reference current I₁, is p+1 times lower. Using the characteristic resistor 106 of decreased size, reduces overall area occupancy of the current source 100. In one example, quantity U_{T} ln(m/n), which equals the voltage across the characteristic resistor 106, is maintained at around 70 to 80 millivolts. To generate the reference current of 1800 nanoamperes, the PMOS transistor 212 which is p=20 times the size of the second PMOS transistor 204, and the characteristic resistor 106 of 2.1 kiloohms need be used. Alternately, for similar value of the characteristic resistor 106, the current source 100 allows for generation of currents that are p+1 lower. For example, for the characteristic resistor 106 of 45 kiloohms and p=20, the lowest reference current generable by the current source 100 is 80 millivolts/(21×45 kiloohms)=85 nanoamperes. The lowest reference current is a constant current that is required for several applications, for example on-chip oscillators, timing and control signals for non-volatile memories. Low level of the current needed by such applications is hence generated without increasing size of the characteristic resistor R₀.

The current I₂, which is the output current that flows into the load 108 and is equal to the reference current I₁ except for a constant of proportionality, equals the ratio of the sizes of the second PMOS transistor 204 and the PMOS transistor 210.

As the reference current depends on the volt-equivalent of temperature U_{T}, and since U_{T} is proportional to the temperature, it follows that the reference current can rise or fall with the temperature. In order to decrease variation with the temperature of the output current, it is desirable to use the characteristic resistor 106 where the resistance increases directly proportional with the temperature. It is easier to find materials with resistivity that have a suitable temperature coefficient, that is, rise linearly with the temperature, when the value of the characteristic resistor 106 is less. Thus, the present disclosure, using a decreased value of the characteristic resistor 106, provides reliable constancy of the output current across the temperature.

The present disclosure can be implemented in different semiconductor technologies. In one example, for a bipolar junction transistor (BJT) technology, PMOS transistors in FIG. 2 can be replaced with PNP transistors and NMOS transistors can be replaced with NPN transistors.

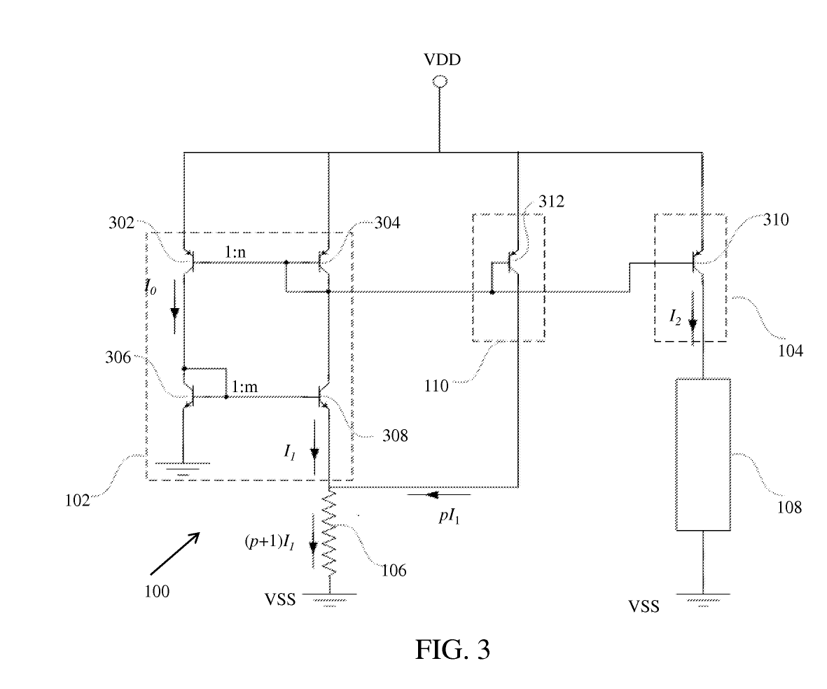

FIG. 3 is a schematic diagram of the current source 100 of Vittoz-style architecture implemented in the BJT technology, in accordance with one embodiment.

PMOS transistors in FIG. 2 can be replaced with PNP transistors, for example a first PNP transistor 302, a second PNP transistor 304, a PNP transistor 310, and a PNP transistor 312. Further, NMOS transistors in FIG. 2 can be replaced with NPN transistors, for example a first NPN transistor 306, and a second NPN transistor 308. The PNP transistors in FIG. 3 operate similar to the PMOS transistors in FIG. 2, and the NPN transistors in FIG. 3 operate similar to the NMOS transistors in FIG. 2.

The PNP transistors and the NPN transistors are biased to be in forward-active mode.

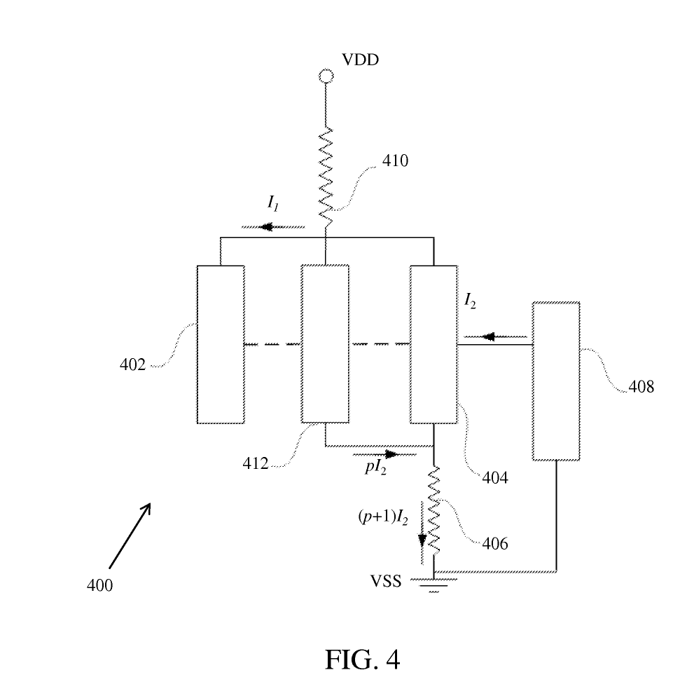

FIG. 4 is a block diagram illustrating a current source 400 of Widlar-style architecture, in accordance with one embodiment.

The current source 400 includes a first circuit 402, a second circuit 404, a characteristic resistor 406, a resistor 410, a third circuit 412, and a load 408. The first circuit 402 is coupled to the power supply (VDD) via the resistor 410, and to the third circuit 412. The second circuit 404 is coupled between the resistor 410 and the characteristic resistor 406, and to the load 408. The third circuit 412 is coupled between the resistor 410 and the characteristic resistor 406, and between the first circuit 402 and the second circuit 404. The characteristic resistor 406 and the load 408 are further coupled to a ground supply (VSS).

In some embodiments, the resistor 410 can be replaced with an input current source.

The first circuit 402 generates a reference current I₁. The second circuit 404 mirrors the first circuit 402. The current U₂ which is a pre-designed multiple of the reference current I₁, is generated by the second circuit 404. The third circuit 412 is an auxiliary current mirror that directs a current which equals a multiple p of the current I₂ into the characteristic resistor 406, thereby allowing reduction of the value of the characteristic resistor 406, or alternately, allowing reduction of lowest generable output current, the current I₂. The current flowing through the characteristic resistor 406 is then p+1 times the current I₂. The current I₂ is further provided to the load 408.

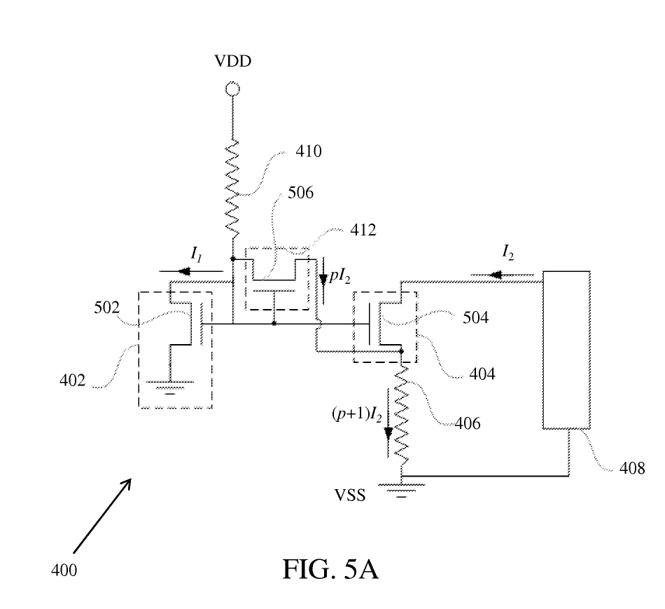

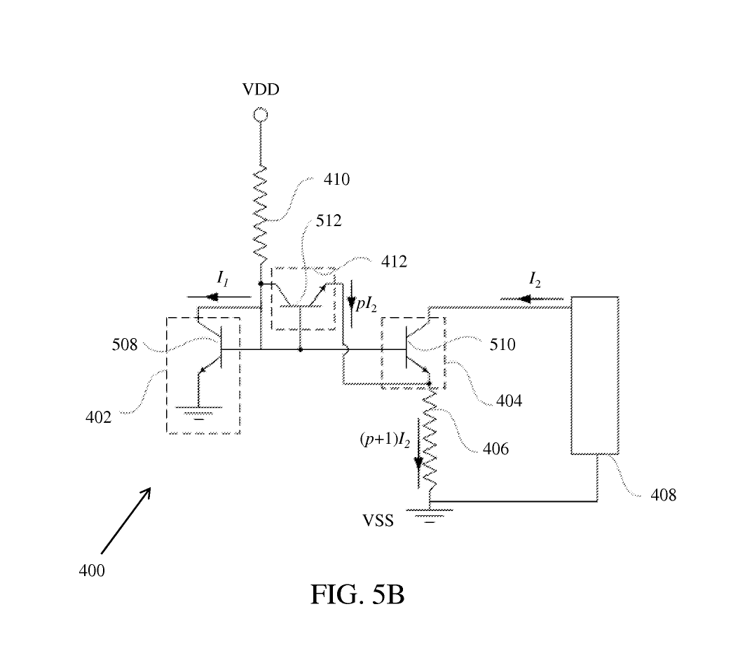

FIG. 5A is a schematic diagram of the current source 400 of Widlar-style architecture implemented in complementary metal oxide semiconductor (CMOS) technology, in accordance with one embodiment.

The first circuit 402 includes an NMOS transistor 502, the second circuit 404 includes an NMOS transistor 504, and the third circuit 412 includes an NMOS transistor 506. The NMOS transistor 502 has a drain coupled to the power supply via the resistor 410, a gate coupled to a gate of the NMOS transistor 504 and to a gate of the NMOS transistor 506, and a source coupled to the ground supply. The NMOS transistor 504 has a drain coupled to the load 408, and a source coupled to the characteristic resistor 406. The NMOS transistor 506 has a drain coupled to the resistor 410, and a source coupled to the characteristic resistor 406.

The NMOS transistor 506 that serves as the auxiliary current mirror is a multiple p times higher than the NMOS transistor 504. The output current which is the current I₂ is generable by the current source 400 of FIG. 5A and is given by equation (3) if size of the NMOS transistor 502 is equal to size of the NMOS transistor 504:

$${I}_{2} = \frac{{U}_{T}}{( p + 1 ) {R}_{0}} ln ( \frac{{I}_{1}}{{I}_{2}} ) , \qquad ( 3 )$$

where R₀ denotes the value of the characteristic resistor 406, and I₁ is the value of the reference current that is determined using the resistor 410. Equation 3 is also applicable when p is set to zero, that is, simulating a situation where the auxiliary current mirror is brought to null. By thus comparing equation 3 under non-zero and zero values of p, it is determined that the current source 400 delivers a p-fold reduction in the value of the characteristic resistor 406, or a p-fold reduction in the lowest generable output current I₂.

FIG. 5B is a schematic diagram of the current source 400 of Widlar-style architecture implemented in bipolar junction transistor (BJT) technology, in accordance with one embodiment.

The first circuit 402 includes an NPN transistor 508, the second circuit 404 includes an NPN transistor 510, and the third circuit 412 includes an NPN transistor 512. The NPN transistor 508 has a drain coupled to the power supply via the resistor 410, a gate coupled to a gate of the NPN transistor 510 and to a gate of the NPN transistor 512, and a source coupled to the ground supply. The NPN transistor 510 has a drain coupled to the load 408, and a source coupled to the characteristic resistor 406. The NPN transistor 512 has a drain coupled to the resistor 410, and a source coupled to the characteristic resistor 406.

The NPN transistor 512 that serves as the auxiliary current mirror is a multiple p times higher than the NPN transistor 510. The output current which is the current I₂ is generable by the current source 400 of FIG. 5B and is given by the following equation:

$${I}_{2} = \frac{{U}_{T}}{( p + 1 ) {R}_{0} ( 1 + \frac{1}{β} )} ln ( \frac{{I}_{1}}{{I}_{2}} ) , \qquad ( 4 )$$

where R₀ denotes the value of the characteristic resistor 406, I₁ is the value of the reference current that is determined using the resistor 410, and β is characteristic gain of the NPN transistor 508, the NPN transistor 510 and the NPN transistor 512. The value of β is usually between 50 and 200 and is similar for each transistor in FIG. 5B, due to being manufactured on one semiconductor die. Equation 4 is also applicable when p is set to zero, that is, simulating a situation where the auxiliary current mirror is brought to null. By thus comparing equation 4 under non-zero and zero values of p, it is determined that the current source 400 delivers a p-fold reduction in the value of the characteristic resistor 406, or a p-fold reduction in the lowest generable output current I₂.

The present disclosure, which uses an auxiliary current mirror to drive current into a characteristic resistor, can be implemented on different current source architectures, including Widlar-style architecture.

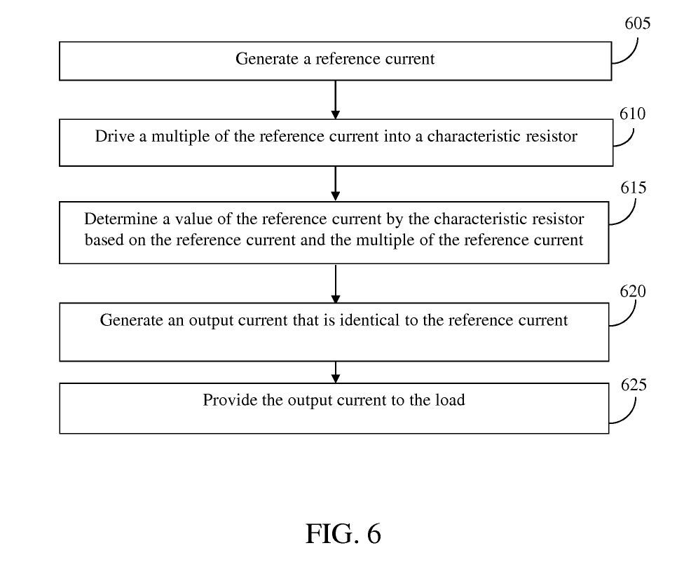

FIG. 6 is a flow diagram illustrating a method of providing a constant current to a load by a current source, for example the current source 100, in accordance with one embodiment.

At step 605, a reference current is generated. The reference current can be generated by a first circuit that includes a first plurality of interconnected transistors, for example p-type metal oxide semiconductor (PMOS) transistors and n-type metal oxide semiconductor (NMOS) transistors.

At step 610, a multiple of the reference current is driven into the characteristic resistor by a third circuit. The third circuit can include a third plurality of interconnected transistors, for example a PMOS transistor.

In some embodiments, a multiple of an output current is driven into the characteristic resistor by the third circuit.

At step 615, a value of the reference current is determined by a characteristic resistor based on the reference current and the multiple of the reference current.

At step 620, the output current that is identical to the reference current is generated. The output current is generated by a second circuit that includes a second plurality of interconnected transistors, for example another PMOS transistor.

At step 625, the output current is provided to the load. The current source hence achieves a desired value of the output current without increasing size of the characteristic resistor.

Use of the current source, as described in the present disclosure, enables generation of low yet stable levels of current. By construction the current source occupies low on-chip area, consumes less power, and provides reliable constancy of current across temperature variations. The current source can be implemented in different semiconductor technologies. The present disclosure applies to one or more current mirror architectures having output current determined by a characteristic resistor.

The foregoing description sets forth numerous specific details to convey a thorough understanding of embodiments of the disclosure. However, it will be apparent to one skilled in the art that embodiments of the disclosure may be practiced without these specific details. Some well-known features are not described in detail in order to avoid obscuring the disclosure. Other variations and embodiments are possible in light of above teachings, and it is thus intended that the scope of disclosure not be limited by this Detailed Description, but only by the Claims.

What is claimed is:

1. A current source for providing a constant current to a load, the current source comprising:
a first circuit that generates a reference current, the first circuit comprising a first plurality of interconnected transistors;
a characteristic resistor, coupled to the first circuit, that determines value of the reference current;
a second circuit, coupled to the first circuit and to the load, that generates an output current that is identical to the reference current, the second circuit comprising a second plurality of interconnected transistors; and
a third circuit, coupled to the first circuit, that drives a multiple of the reference current into the characteristic resistor, the third circuit comprising a third plurality of interconnected transistors.

2. The current source as claimed in claim 1, wherein the second circuit comprises a current mirror to the first circuit, and the third circuit comprises an auxiliary current mirror to the first circuit.

3. The current source as claimed in claim 1, wherein the first circuit comprises a first p-type metal oxide semiconductor (PMOS) transistor having a source coupled to a power supply;
a second PMOS transistor having a gate coupled to a gate of the first PMOS transistor and a source coupled to the power supply;
a first n-type metal oxide semiconductor (NMOS) transistor having a drain coupled to a drain of the first PMOS transistor and a source coupled to the ground supply; and
a second NMOS transistor having a gate coupled to a gate of the first NMOS transistor, a drain coupled to a drain of the first PMOS transistor, and a source coupled to the characteristic resistor.

4. The current source as claimed in claim 3, wherein the first PMOS transistor and the second PMOS transistor are biased to be in saturation mode, and the first NMOS transistor and the second NMOS transistor are biased to be in weak inversion mode.

5. The current source as claimed in claim 4, wherein the second circuit comprises
a PMOS transistor having a gate coupled to the gate of the first PMOS transistor, a source coupled to the power supply, and a drain coupled to the load.

6. The current source as claimed in claim 5, wherein the third circuit comprises
a PMOS transistor having a gate coupled to the gate of the first PMOS transistor, a source coupled to the power supply, and a drain coupled between the source of the second NMOS transistor and the characteristic resistor.

7. The current source as claimed in claim 1, wherein the first circuit comprises:
a first PNP transistor having an emitter coupled to a power supply;
a second PNP transistor having a base coupled to a base of the first PNP transistor and an emitter coupled to the power supply;
a first NPN transistor having a collector coupled to a collector of the first PNP transistor and an emitter coupled to the ground supply; and
a second NPN transistor having a base coupled to a base of the first NPN transistor, a collector coupled to a collector of the first PNP transistor, and an emitter coupled to the characteristic resistor.

8. The current source as claimed in claim 7, wherein the first PNP transistor, the second PNP transistor, the first NPN transistor, and the second NPN transistor are biased to be in forward-active mode.

9. The current source as claimed in claim 8, wherein the second circuit comprises
a PNP transistor having a base coupled to the base of the first PNP transistor, an emitter coupled to the power supply, and a collector coupled to the load.

10. The current source as claimed in claim 9, wherein the third circuit comprises
a PNP transistor having a base coupled to the base of the first PNP transistor, an emitter coupled to the power supply, and a collector coupled between the emitter of the second NPN transistor and the characteristic resistor.

11. A current source for providing a constant current to a load, the current source comprising:
a first circuit that generates a reference current;
a second circuit, coupled to the first circuit and to the load, that generates an output current that is identical to the reference current;
a characteristic resistor, coupled to the second circuit, that determines value of the reference current;
a third circuit, coupled between the first circuit and the second circuit, that drives a multiple of the output current into the characteristic resistor; and
a resistor, coupled to the first circuit.

12. The current source as claimed in claim 11, wherein the second circuit comprises a current mirror to the first circuit, and the third circuit comprises an auxiliary current mirror to the first circuit.

13. The current source as claimed in claim 11, wherein the first circuit comprises
a first metal oxide semiconductor (MOS) transistor having a drain and a gate coupled to a first end of the resistor, and a source coupled to a common return.

14. The current source as claimed in claim 13, wherein the second circuit comprises
a second MOS transistor having a gate coupled to the gate of the first MOS transistor, a drain coupled to the load, and a source coupled to the characteristic resistor.

15. The current source as claimed in claim 14, wherein the third circuit comprises
a third MOS transistor having a gate coupled to the gate of the first MOS transistor, a drain coupled to the drain of the first MOS transistor, and a source coupled to the source of the second MOS transistor.

16. The current source as claimed in claim 11, wherein the first circuit comprises
a first bipolar junction transistor (BJT) having a collector and a base coupled to a first end of the resistor, and an emitter coupled to the ground supply.

17. The current source as claimed in claim 16, wherein the second circuit comprises
a second BJT transistor having a base coupled to the base of the first BJT transistor, a collector coupled to the load, and an emitter coupled to the characteristic resistor.

18. The current source as claimed in claim 17, wherein the third circuit comprises
a third BJT transistor having a base coupled to the base of the first BJT transistor, a collector coupled to the collector of the first BJT transistor, and an emitter coupled to the emitter of the second BJT transistor.

19. A method of providing a constant current to a load, the method comprising:
generating a reference current;
driving a multiple of the reference current into a characteristic resistor;
determining a value of the reference current by the characteristic resistor based on the reference current and the multiple of the reference current;
generating an output current that is identical to the reference current;
providing the output current to the load.

20. The method as claimed in claim 19, wherein the reference current is generated by a circuit comprised of a plurality of p-type metal oxide semiconductor (PMOS) transistors and a plurality of n-type metal oxide semiconductor (NMOS) transistors.

21. The method as claimed in claim 19, wherein the plurality of PMOS transistors are biased to be in saturation mode, and the plurality of NMOS transistors are biased to be in weak inversion mode.

22. The method as claimed in claim 19, wherein the output current is generated by a current mirror.

23. The method as claimed in claim 19, wherein the multiple of the reference current is driven into the characteristic resistor by an auxiliary current mirror.
